(19) United States
(12) Patent Application Publication
(10) Pub. No.: US 2010/0120956 A1
(43) Pub. Date: May 13, 2010

(54) Method for Production of Natural Rubber

(75) Inventors: Tetsuji Kawazura, Kanagawa (JP); Takashi Kakubo, Kanagawa (JP)

Correspondence Address: CARRIER BLACKMAN AND ASSOCIATES, 43440 WEST TEN MILE ROAD, EATON CENTER, NOVI, MI, 48375, US

(73) Assignee: THE YOKOHAMA RUBBER CO., LTD., Tokyo (JP)

(21) Appl. No.: 12/451,307

(22) PCT Filed: Apr. 8, 2008
(86) PCT No.: PCT/JP2008/057228

§ 371 Date: Nov. 5, 2009

(30) Foreign Application Priority Data
May 22, 2007 (JP) 2007-135255
Apr. 4, 2008 (JP) 2008-098494

(51) Int. Cl. C08K 5/19

(52) U.S. Cl. 524/236

(57) ABSTRACT

A method for producing a solid natural rubber by adding a compound having a quaternary ammonium ion and a carboxyl ion in the molecule thereof to a natural rubber latex and removing and drying a water content of the latex, whereby the increase in the viscosity during storage can be suppressed.

### TECHNICAL FIELD

The present invention relates to a method for producing natural rubber, more specifically it relates to a method for producing natural rubber, in which solid natural rubber suppressed in the increase of viscosity of the raw rubber during storage by adding a compound having a quaternary ammonium ion and a carboxyl ion in the molecule thereof into a natural rubber latex, followed by drying.

### BACKGROUND ART

Natural rubber is a non-petroleum dependent resource and has superior dynamic physical properties, and therefore, has been increasing in the importance thereof. At the present time, the natural rubber distributed for production of rubber products mainly includes latex grade technical specified rubber (TSR) produced by tapping the trunks of rubber trees (Hevea brasiliensis) in the Southeast Asian countries, China, some of the African countries, etc. to obtain latex, coagulating the latex thus obtained by acid, squeezing out the moisture, finely chopping it, then drying it by hot air; general grade TSR produced by collecting harvested latex coagulated by an acid or naturally as a material, finely chopping it up, rinsing it to remove the foreign materials mixed therein, repeating these steps, then drying the crumbs by a dryer by hot air; ribbed smoke sheets (RSS) produced by coagulating harvested latex by an acid, etc., forming the coagulated rubber into sheets by ribbed rolls, naturally drying the sheets in an open air, smoke drying the dried sheets, and visually cutting out the foreign-matter, mixed therein, etc.

The present inventors previously proposed in Patent Document 1 to use a pulse wave generated by pulse combustion to dry the natural rubber latex instantaneously directly at a low temperature, without coagulating, proposed in Patent Document 2 to produce natural rubber capable of decreasing the viscosity and remarkably easy to process by not only just drying the latex of natural rubber as it is, but performing various types of chemical treatment in the latex state, and further proposed, in Patent Document 3, a method for producing natural rubber comprising adding a compound having a quaternary ammonium ion in the molecule thereof to a latex of natural rubber to remove the moisture (i.e., water content) and dry the resultant rubber, whereby vulcanized rubber having a low hyesteresis loss can be obtained.

Patent Document 1 Japanese Patent Publication (A) No. 2005-194503

Patent Document 2 Specification of Japanese Patent Application No. 2006-228149 (Japanese Patent Publication (A) No. 2007-146114)

Patent Document 3 Specification of Japanese Patent Application No. 2007-016541

### DISCLOSURE OF THE INVENTION

An object of the present invention is to provide a method for producing natural rubber capable of solving the problem of natural rubber (i.e., raw rubber), i.e., the increase in viscosity during storage.

In accordance with the present invention, there is provided a method for producing a solid natural rubber comprising:
adding a compound having a quaternary ammonium ions and a carboxyl ion in the molecule thereof to a natural rubber latex and;
removing and drying a water content of the latex.

According to the present invention, it is possible to obtain a solid natural rubber suppressed in the increase of the viscosity during storage by adding a compound having a quaternary ammonium ion and a carboxyl ion in the molecule thereof to natural rubber in the latex state, followed by and dissolving the mixture stirring, then drying the natural rubber, without coagulating and possible to reduce the mastification costs of the rubber.

### BEST MODE FOR CARRYING OUT THE INVENTION

The inventors engaged in research to directly produce natural rubber free from curing (or increase in the viscosity) during storage, from a natural rubber latex and, as a result, discovered that a solid natural rubber obtained by adding a compound having a quaternary ammonium ion and a carboxyl ions in the molecule thereof shown by the following formula (I) to a latex state natural rubber, stirring the mixture to dissolve, then drying the natural rubber without coagulating can be suppressed in curing (i.e., increase in the viscosity) during storage, whereby the present invention has been completed.

As the compound having a quaternary ammonium ion and a carboxyl ion usable in the present invention, it is possible to mention the compounds having the following formula (I):

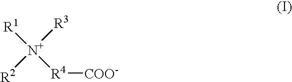

wherein R¹, R² and R³ independently indicate an organic groups selected from C₁ to C₂₀, preferably C₁ to C₁₀ alkyl groups, C₆ to C₂₀, preferably C₆ to C₁₆ aryl groups, and C₇ to C₂₀, preferably C₇ to C₁₇ aralkyl groups, may include an ester bond and/or an amide bond, and R⁴ indicates a C₁ to C₁₂, preferably C₁ to C₆ alkylene group.

The addition amount of the compound having a quaternary ammonium ion and a carboxyl ion is preferably 0.001 to 0.1 mol %, more preferably 0.008 to 0.08 mol %, based upon to the 1.0 kg in terms of the solid content of the natural rubber latex. If this amount is small, the increase in the viscosity during storage is liable not to be suppressed, while if conversely large, an effect commensurate with the amount is liable not to be obtained and the cost is liable to rise.

According to the present invention, the natural rubber latex including a compound having a quaternary ammonium ion and a carboxyl ions in the molecule thereof can be prepared by any method. For example, it is produced by adding a predetermined amount of said compound into a natural rubber latex at ordinary temperature in the atmosphere, while stirring. In a preferable aspect of the present invention, the natural rubber latex is dried by removing the moisture (i.e., water content). As the method for removing the moisture for drying, it is possible to use a generally known method, but the method of spraying the natural rubber latex in a pulse atmosphere to dry it enables drying at a relatively low temperature in a short time, and therefore, can be preferably used. Pulse drying can dry a natural rubber latex to produce rubber using, for example, a pulse burner generating pulse shock waves described in Japanese Patent Publication (A) No. 7-71875 etc. In the present invention, this sort of pulse drier is used to spray dry a latex with preferably a solid content of 70% by weight or less in a drying chamber under conditions of preferably a frequency of 250 to 1200 Hz, more preferably 300 to 1000 Hz, preferably a temperature 140° C. or less, more preferably 40 to 100° C., and 100 to 200 dB (decibel).

It is generally known in the art that natural rubber increases in viscosity along with time. For this reason, in the past, sometimes a viscosity stabilizer is included in natural rubber to suppress the increase in the viscosity of the natural rubber. In the present invention as well, if necessary, it is possible to include a viscosity stabilizer in the natural rubber latex spray dried in an atmosphere of shock waves caused by pulse combustion.

As the viscosity stabilizer usable in the present invention, it is possible to use any viscosity stabilizer generally used in the past not liable to break down under the above pulse drying conditions. Specifically, for example, at least one of hydroxylamine sulfate ((NH₂OH)₂.H₂SO₄), semicarbazide (NH₂CONHNH₂), dimedone (1,1-dimethylcyclohexane-3,5-dione), etc. may be used.

The natural rubber produced in the present invention, for example, may be blended with a conventional diene-based rubber, carbon black or silica or the other fillers, a vulcanization or cross-linking agent, a vulcanization or cross-linking accelerator, various types of oils, an antioxidant, plasticizer, and various other types of additives generally compounded for tire use or other rubber composition use so as to obtain a rubber composition. The additives may be mixed by a general method to obtain a composition for use for vulcanization or cross-linking. The amounts of these additives may be made the conventional general amounts so long as the object of the present invention is not adversely affected.

### EXAMPLES

Examples will now be used to further illustrate the present invention, but the scope of the present invention is by no means limited to these Examples.

### Standard Example 1

### Examples 1 to 2 and Comparative Examples 1 to 5

(1) Treatment of Latex

To untreated field latex (made in Thailand, ammonia concentration=0.5 wt %, solid content concentration=about 30 wt %), the treatment chemical shown in Table I was added, based upon the solid content, and the mixture stirred at room temperature for about 6 hours. The mixture was allowed to stand for a while and the state after addition (i.e., presence or absence of any coagulation) was confirmed (see Table I). The precipitate was removed, then the resultant mixture was processed by a centrifuge at 12000 rpm for 30 minutes. Distilled water was added to the creamy substance thus obtained to be dispersed to a DRC (i.e., dry rubber content) of about 60%.

TABLE I

| | Stand. Ex. 1 (NR1) | Comp. Ex. 1 (NR2) | Comp. Ex. 2 (NR3) | Comp. Ex 3 (NR4) | Comp. Ex. 4 (NR5) | Ex. 1 (NR6) | Ex. 2 (NR7) | Comp. Ex. 5 (NR8) |
|---|---|---|---|---|---|---|---|---|
| Latex used | Field latex (solid content 30 wt %) | | | | | | | |
| Latex treatment | HYDA*¹ | SDS*² | TR-701*³ | TR-913*⁴ | DM-30A^{*5} | PB-30L*⁶ | AB-35L*⁷ | MD-100*⁸ |
| chemical | | | | | | | | |
| Amount added: | 0.008 | 0.008 | 0.008 | 0.008 | 0.008 | 0.008 | 0.008 | 0.008 |
| mol/kg rubber | | | | | | | | |
| State after | No | No | Partial | Partial | Coagulation | No | No | Partial |
| addition | coagulation | coagulation | coagulation | coagulation | | coagulation | coagulation | coagulation |
| Mooney | | | | | | | | |
| viscosity^{(Note)} | | | | | | | | |
| After 24 hours | 82 | 86 | — | — | — | 90 | 92 | — |
| after drying | | | | | | | | |
| After elapse of 48 | 86 | 103 | — | — | — | 97 | 96 | — |
| hours at 60° C. | | | | | | | | |
| Rate of change (%) | +5 | +20 | — | — | — | +8 | +4 | — |

^{(Note)}Mooney viscosity according to JIS K6300, determined after drying natural rubber for 24 hours and after 60° C. × 48 hours (after holding in gear oven).
Note of Table I
*¹HYDA (hydroxylamine sulfate made by Tokyo Kasei Industry Co., Ltd.)
*²SDS (sodium dodecyl benzenesulfonate made by Tokyo Kasei Industry Co., Ltd.)
*³ to *⁸All made by ADEKA and having the following chemical structrures:
*³TR-701 (made by ADEKA) 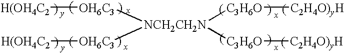
*⁴TR-913R (made by ADEKA) 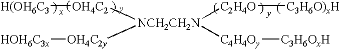
*⁵DM-30A (made by ADEKA) 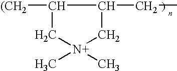
*⁶PB-30L (made by ADEKA) 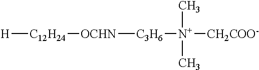
*⁷AB-35L (made by ADEKA) 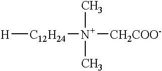
*⁸MD-100 (made by ADEKA)

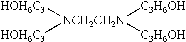

Test of Increase in Viscosity of Raw Rubber During Storage

The extents of the increase in the viscosity of the samples of the Examples and Comparative Examples were investigated by comparing the initial Mooney viscosities and the Mooney viscosities after standing at 60° C. for 48 hours in a drying atmosphere. The results are shown in Table I. It is clear that the Examples of the present invention have smaller changes in the viscosities. Note that the change in the viscosity of the Standard Example using HYDA (hydroxylamine sulfate) is also small, but HYDA is not preferable in terms of the safety and health, and, therefore, is preferably not used.

Method of Evaluation and Testing of Rubber Physical Properties

The rubber physical properties of the natural rubbers obtained in Examples 1 to 9 and Comparative Examples 1 to 3 were compared. In each of the formulations shown in Table II, the ingredients other than the vulcanization accelerator and sulfur were kneaded by a 1.7 liter Banbury mixer (Trademark) for 5 minutes. The mixture was discharged when reaching 140° C. to obtain a master batch. The vulcanization accelerator and sulfur were kneaded to this master batch by an 8-inch open roll to obtain a rubber composition. The results are shown in Table II. It is learned that the Examples of the present invention exhibit physical properties with no different compared with the natural rubber usually used as vulcanized rubber (see Reference Examples 1 to 5).

Mooney viscosity: Determined according to a JIS K6300 method

Rheometer: Determined according to an ASTM D2084 method

Tensile test: Determined according to a JIS K6251 method

Rupke resilience: Resilience at temperature of 20° C. determine according to a JIS K6255 method

Abrasion: A Lambourn abrasion tester was used to determine the abrasion according to a JIS K6264 method under conditions of a load of 4.0 kg and a slip rate of 30%. The results were shown, as indexed to the amount of abrasion of Reference Example 2 as 100. The larger the index, the better the abrasion resistance.

TABLE II

| | | Parts by |
|---|---|---|
| Compounding Ingredients | | weight |
| Natural rubber | See Table I | 100 |
| Carbon black | Shoblack N330 (made by Showa Cabot) | 45 |
| (N330) | | |
| Zinc white | Zinc white JIS No. 3 (Seido Chemical | 5 |
| | Ind.) | |
| Stearic acid | Kogyouyou stearic acid (ADEKA) | 3 |
| Antioxidant | Nocrac 6C (Ouchi Shinko Chemical Ind.) | 1 |
| (6PPD) | | |
| Vulcanization | Sancelar NS (Sanshin Chemical Ind.) | 0.7 |
| accelerator | | |
| (TBBS) | | |
| Powdered sulfur | Powdered sulfur (Karuizawa Refinery) | 2 |

TABLE III

| | | | | | | | |
|---|---|---|---|---|---|---|---|
| | Ref. | Ref. | Ref. | Ref. | Ref. | Stand. | Comp. |
| | Ex. 1 | Ex. 2 | Ex. 3 | Ex. 4 | Ex. 5 | Ex. 1 | Ex. 1 |
| Natural rubber | CV60 | STR20 | SIR20 | RSS#1 | RSS#3 | (NR1*¹) | (NR2*¹) |

Mooney viscosity

| | | | | | | | | |
|---|---|---|---|---|---|---|---|---|
| Test temp./100° C. | INT [Mooney] | 100 | 109 | 106 | 175 | 136 | 137 | 165 |
| Rotor/L | Vis [Mooney] | 57 | 53 | 57 | 71 | 66 | 56 | 62 |

Rheometer

| | | | | | | | | |
|---|---|---|---|---|---|---|---|---|
| Test temp./148° C. | T30 [min] | 7.3 | 6.4 | 6.9 | 5.8 | 7.2 | 5.2 | 5.2 |
| | T95 [min] | 14.8 | 13.7 | 14.1 | 13.6 | 15.2 | 11.1 | 11.8 |
| | MH [N · m] | 1.484 | 1.474 | 1.517 | 1.55 | 1.54 | 1.44 | 1.44 |

Tensie test (vulcanization 148° C. × 30 min)

| | | | | | | | |
|---|---|---|---|---|---|---|---|
| M100 [MPa] | 3.1 | 3.0 | 3.0 | 3.2 | 3.1 | 3.1 | 3.1 |
| M300 [MPa] | 15.9 | 15.5 | 15.1 | 16.4 | 16.2 | 15.9 | 16.2 |
| T_{B} [MPa] | 30.6 | 29.7 | 27.6 | 30.4 | 29.7 | 30.1 | 29.9 |
| E_{B} [%] | 506 | 502 | 478 | 499 | 483 | 485 | 491 |

Rupke resilience (vulcanization 148° C. × 30 min)

| | | | | | | | | |
|---|---|---|---|---|---|---|---|---|
| Test temp./20° C. | Resilience | 60 | 63 | 62 | 62 | 65 | 64 | 66 |

Lambourn abrasion test (vulcanization 148° C. × 30 min)

| | | | | | | | |
|---|---|---|---|---|---|---|---|
| Abrasion index | 105 | 100 | 102 | 104 | 109 | 102 | 102 |
| [%] | | | | | | | |

| | | | | | | |
|---|---|---|---|---|---|---|
| | Comp. | Comp. | Comp. | | | Comp. |
| | Ex. 2 | Ex. 3 | Ex. 4 | Ex. 1 | Ex. 2 | Ex. 5 |
| Natural rubber | (NR3*¹) | (NR4*¹) | (NR5*¹) | (NR6*¹) | (NR7*¹) | (NR8*¹) |

Mooney viscosity

| | | | | | | | |
|---|---|---|---|---|---|---|---|
| Test temp./100° C. | INT [Mooney] | 137 | 136 | 126 | 152 | 150 | 156 |
| Rotor/L | Vis [Mooney] | 55 | 56 | 53 | 59 | 56 | 59 |

Rheometer

| | | | | | | | |
|---|---|---|---|---|---|---|---|
| Test temp./148° C. | T30 [min] | 4.2 | 4.9 | 4.5 | 4.6 | 4.9 | 4.7 |
| | T95 [min] | 10.4 | 11.1 | 11.0 | 11.0 | 11.2 | 10.9 |
| | MH [N · m] | 1.45 | 1.47 | 1.47 | 1.46 | 1.46 | 1.46 |

Tensile test (vulcanization 148° C. × 30 min)

| | | | | | | |
|---|---|---|---|---|---|---|
| M100 [MPa] | 3.1 | 3.1 | 3.4 | 3.3 | 3.1 | 3.2 |
| M300 [MPa] | 15.4 | 15.9 | 16.7 | 16.2 | 16.2 | 16.3 |
| T_{B} [MPa] | 30.2 | 30.7 | 29.7 | 29.7 | 30.9 | 30.0 |
| E_{B} [%] | 517 | 512 | 483 | 493 | 504 | 502 |

Rupke resilience (vulcanization 148° C. × 30 min)

| | | | | | | | |
|---|---|---|---|---|---|---|---|
| Test temp./20° C. | Resilience | 65 | 67 | 66 | 65 | 68 | 65 |

Lambourn abrasion test (vulcanization 148° C. × 30 min)

| | | | | | | |
|---|---|---|---|---|---|---|
| Abrasion index | 106 | 99 | 108 | 102 | 107 | 106 |
| [%] | | | | | | |

*¹See Table I

### INDUSTRIAL APPLICABILITY

According to the method of the present invention, it is possible to produce natural rubber suppressed in the increase of the viscosity during storage from a natural rubber latex, and therefore, the present invention is useful for utilization as tires, conveyor belts, rubber supports, and other various rubber products.

1. A method for producing solid natural rubber comprising:
adding a compound having a quaternary ammonium ion and a carboxyl ion in the molecule thereof to a natural rubber latex and;
removing and drying a water content of the latex.

2. A method for producing natural rubber as claimed in claim 1, wherein said compound having a quaternary ammonium ion and a carboxyl ion is a compound having the formula (I): 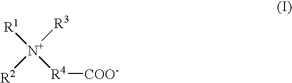
wherein R¹, R² and R³ independently indicate an organic groups selected from C₁ to C₂₀ alkyl groups, C₆ to C₂₀ aryl groups and C₇ to C₂₀ aralkyl groups, may include an ester bond and/or an amide bond, and R⁴ indicates a C₁ to C₁₂ alkylene group.

3. A method for producing natural rubber as claimed in claim 1, wherein the addition amount of said compound having a quaternary ammonium ion and a carboxyl ion is 0.001 to 0.1 mol based upon 1.0 kg, in terms of the solid content, of the natural rubber latex.

4. A method for producing natural rubber as claimed in claim 1, wherein the natural rubber latex is a field latex, a concentrated latex or the mixture thereof.

5. A method for producing natural rubber as claimed in claim 1, characterized in that a water content of the natural rubber latex is dried by exposing the natural rubber latex to pulse shock waves to thereby dry off the water content.

6. A natural rubber produced by a method as claimed in claim 1.
